(19) United States
(12) Patent Application Publication
(10) Pub. No.: US 2015/0303524 A1
(43) Pub. Date: Oct. 22, 2015

(54) ELECTROCHEMICAL STORAGE OF THERMAL ENERGY

(71) Applicant: Yeda Research and Development Co., Ltd., Rehovot (IL)

(72) Inventor: Michael EPSTEIN, Rishon LeZion (IL)

(21) Appl. No.: 14/424,039

(22) PCT Filed: Aug. 27, 2013
(86) PCT No.: PCT/IL2013/050723

§ 371 Date: Feb. 26, 2015

Related U.S. Application Data
(60) Provisional application No. 61/694,005, filed on Aug. 28, 2012.

(51) Int. Cl. H01M 10/39

(52) U.S. Cl. CPC H01M 10/399

(57) ABSTRACT

The invention relates to an energy conversion and storage system and a method wherein a battery catholyte composition (e.g., following or during a discharge process) is decomposed by heating to produce a decomposed catholyte and separate an anolyte component therefrom, thereby enabling use of the anolyte component and a remainder of the decomposed catholyte in anodic and cathodic half-cells of an electrochemical energy storage device.

### TECHNOLOGICAL FIELD

The present application provides techniques for conversion and storage of thermal energy in a battery.

### BACKGROUND

A crucial issue for concentrated solar power (CSP) technologies today is providing energy storage means capable of accumulating dispatchable power by storing solar energy. It is recognized today that further commercial deployment of CSP on a large scale depends on increasing the solar capacity factor (annual contribution of solar electricity) and proper dispatchability to cope with the intermittent nature of this renewable power resource.

Thermal storage concepts proposed and developed heretofore are mainly based on final production of steam in the discharge of the storage and operating a Rankine cycle. These solutions typically result in 20-25% peak conversion efficiency from solar input to electricity and with a conversion efficiency of about 15-20% on annual average. A main reason for these rather low efficiency figures (resulting in economical competitiveness deficiency) is due to the fact that in addition to inevitable optical and thermal losses incurring in the solar field, the receiver and the storage subsystems, which amount to about 40-45% of the solar input (losses), a 35-40% penalty factor also exists in the power-block unit in the process of converting heat energy into electricity. This results in a final efficiency of about 15-20% from solar to electricity.

Additionally, the power blocks currently used in the CSP plants costs about 15-25% of the total initial investment (depending on the size of the storage unit), and require large amounts of water (for cooling the condenser of the steam cycle), which are scarce and costly in arid areas, wherein solar plants are customarily built.

A thermally regenerated fuel cell utilizing a solid electrolyte is described in U.S. Pat. No. 3,404,036. In this patent the energy storage device utilized comprises a solid reaction zone separator positioned between anodic and cathodic reaction zones which are in fluid connection with a decomposition chamber, wherein the solid reaction zone separator comprises a solid crystalline electrolyte.

### GENERAL DESCRIPTION

The present invention provides energy storage techniques allowing conversion of heat energy into electrochemical energy that is stored in an electrochemical cell. The techniques disclosed herein preclude the use of a turbine to convert heat to electricity as currently done nowadays in conventional solar plants, and the electricity is directly obtained from the electrochemical cell during its discharge cycle. Moreover, the energy storage techniques disclosed herein preclude the use of electric power generators (e.g., turbines, wind turbines, photovoltaic panels) which are often used to recharge electrochemical cells by applying electrical power to the cells' electrode terminals.

The inventor of the present invention developed new efficient techniques usable to convert thermal energy into electrochemical energy, and for storing the same in energy storage devices (electrochemical cell/rechargeable batteries) based on sodium-sulfur battery/cell technology. Typically, electrochemical cells are recharged nowadays by connecting electric power sources to the electrodes of the cells to reverse a chemical reaction occurring between catholyte and anolyte components of the cell during normal discharge operation.

The energy conversion and storage techniques disclosed herein are fundamentally different from conventional electro-chemical storage techniques used nowadays mainly in that a high temperature (e.g., about 1500-1700° C.) thermal energy source (e.g., concentrated solar radiation) is utilized for thermo-chemically charging the electrochemical cells, rather than the conventional electrical charging of these cells e.g., by photovoltaic (PV) cells or wind power resources. More particularly, the present invention provides techniques for thermo-chemically recharging the electrochemical cells by heating a catholyte composition received from the electrochemical cells to decomposition thereof, separating from the obtained decomposition an anolyte component and a catholyte component, and transferring the separated components to the electrochemical cells, directly or through intermediate storage tanks, for use in their discharge cycles.

The techniques described herein may be used to obtain a total efficiency of about 50% in the conversion from solar thermal energy to electrical energy (i.e., at least twice the efficiency of currently available solutions), which may result in substantial economical impact on CSP technologies. Additionally, by using the techniques disclosed in this application, significant portions of the initial investment costs involved in the power block subsystem of a regular CSP plant may be saved.

In possible embodiments the catholyte component comprises Sulfur and the anolyte component comprises Sodium. For example, and without being limiting, the electrochemical cell may be a type of Sodium-Sulfur (Na—S) cell which produces sodium polysulfide (the catholyte composition) during its discharge process.

Some embodiments of the present invention employ electrochemical cells of the Na—S type, as electrochemical energy storage devices. To this end, the term anolyte is used herein to generally refer to the Na part of these electrochemical cells as residing in an anodic half-cell of an electrochemical cell, where the sodium anolyte is converted to sodium ions, and the term catholyte is used to generally refer to the sulfur part of the cell as material residing in a cathodic half-cell of the electrochemical cells. During the course of the discharge cycle the composition of the catholyte is changed as the sulfur reacts with the sodium and the sodium polysulfide content in the catholyte is increased.

In some embodiments when the discharge cycle is completed (e.g., when the concentration of the sodium polysulfide in the catholyte is about 60-90%, for example, depending on the storage dispatchability management) the catholyte, containing mainly sodium polysulfide (with remaining sulfur) is pumped from the cathodic half-cell (or from a buffer storage tank attached to it) for thermal decomposition, which is somewhat equivalent to the conventional electrical charging cycle.

The present invention in some of its embodiments provides a system and method for converting and storing energy received from thermal energy resources in electrochemical energy storage devices (also referred to herein as batteries or electrochemical cells). The energy storage device comprises anolyte and catholyte materials disposed in respective anodic and cathodic half-cells separated by a membrane configured to permit selective cross-transport of ion species therebetween. More specifically, for the Na—S battery, sodium ions migrate from the anolyte part during the discharge phase to the catholyte part containing sulfur and react with it to form sodium polysulfide (Na₂Sₓ), which accumulates in the catholyte during the discharge phase. Namely, the catholyte, which before commencement of the discharge cycle contains pure sulfur, turns to a mixture of mostly sodium polysulfide and some remaining sulfur. During the charging cycle, according to some embodiments of the present invention, the sodium polysulfide is decomposed into sodium and sulfur, the sodium is returned back to the anolyte side and the sulfur to the catholyte side (e.g., through storage tanks).

In some embodiments of the present invention, thermal energy is used in recharge cycles of the electrochemical cells to heat catholyte composition, drawn from the cathodic half-cell of the energy storage device after (or during) the discharge cycle, to a decomposition temperature thereof. The decomposed catholyte is cooled to separate an anolyte component therefrom, and then a remainder of the decomposed catholyte is condensed to separate the catholyte component therefrom. The extracted anolyte and catholyte components may be transferred into respective anodic and cathodic half-cells of the electrochemical cell to complete the recharge cycle.

The extracted anolyte and catholyte components may be cooled to a working temperature of the electrochemical cell (e.g., 320° C. to 380° C.) before they are transferred into their respective half-cells. For example, and without being limiting, the extracted anolyte and catholyte components may be stored in respective catholyte and anolyte vessels configured to receive and store these extractions and cool them to the working temperature of the electrochemical cell.

The present disclosure provides, in some embodiments, an energy conversion system comprising a heating apparatus configured to heat a catholyte composition to a decomposition temperature thereof, and a separator configured to cool (e.g., to about 460-500° C.) and separate anolyte and catholyte components from the decomposed catholyte to be used in respective anolyte and catholyte half-cells of an electrochemical energy storage device. In some embodiments the separator is configured and operable to separate the anolyte component under application of vacuum conditions of about 2 to 8 mbar (absolute, corresponding to the vapor pressure of the condensed liquid sodium at the operating temperature of the separator) to the catholyte composition.

The energy storage device typically includes in the anodic half-cell a negative terminal (e.g., made of stainless steel), in the cathodic half-cell a positive terminal (e.g., made of stainless steel), and a membrane e.g., made of sodium β-alumina (NaAl₁₁0₁₇) which separates between the half-cells and which is configured to permit selective migration of ionic species from the anodic half-cell to the cathodic half-cell (ions of sodium which migrate and react with the sulfur to form sodium polysulfide).

The heating apparatus used to decompose the catholyte composition in the charging cycle may utilize concentrated solar energy as a heat source. For example and without being limiting, in possible embodiments the heating apparatus comprises a solar tower having a solar reactor configured to receive thermal energy from a solar concentrator and heat the catholyte composition after (or during) the discharge cycle to its decomposition temperature (e.g., 1400 to 1900° C.), thereby obtaining a gaseous mixture comprising vaporized anolyte and catholyte components (also referred to herein as vapor decomposition). In some embodiments the catholyte composition is heated to its decomposition temperature under application of vacuum conditions of about 0.01 to 1 bar (absolute) to the decomposed catholyte.

The system may further include a pump for streaming catholyte composition from the cathodic half-cell of the energy storage device to the heating device. Specifically, in the Na—S battery the sodium polysulfide, Na₂Sₓ, is streamed from the cathodic half cell to the solar reactor where it decomposes to its sodium, Na, and sulfur, S, electrolyte components. The vapor decomposition is discharged from the solar reactor and then cooled, separated and returned to the respective half cells and thus charge the battery.

In possible embodiments the separator includes a separator tank configured to receive a stream of the vapor decomposition from the heating device and separate said decomposed catholyte to the anolyte component and the remainder of the decomposed catholyte. The separator tank may be in a fluid connection with the anodic half-cell for transferring the anolyte component in a liquid phase to the anodic half-cell. For example and without being limiting, the separator tank may be configured to spray/sprinkle on the stream of the vapor decomposition received from the heating device a cold fluid stream (e.g., comprising cooled anolyte component and/or inert gas) to thereby quench the vapor mixture and condense the anolyte component from the vapor decomposition into a liquefied state.

The separator may include a condenser configured to receive remainders of the vapor decomposition in a gas phase via a vapor outlet of the separator tank, and to extract/separate a catholyte component from said vapors remainders. For example and without being limiting, the condenser may be configured and operable to cool the remainder of the decomposed catholyte to a working temperature of the electrochemical energy storage device. The condenser may be in a fluid connection with the cathodic half-cell for transferring the separated catholyte component in a liquid phase to the cathodic half-cell. The separator tank may further include a fluid outlet for removing the liquefied anolyte from the separator and a gas outlet for removing the remainder of the decomposed cathoyte mixture.

The system may include anolyte and catholyte vessels configured to respectively receive from the separator the extracted anolyte and catholyte components, bring them to a working temperature of the energy storage device, and thereafter transfer them to respective anodic and cathodic half-cells in the energy storage device. The anolyte vessel may be configured as a circulating tank that receives the extracted cooled, liquefied anolyte from the fluid outlet of the separator tank, and streams the liquefied anolyte through a circulating line connected to a spraying/sprinkling inlet of the separator tank. The spraying/sprinkling inlet is configured to spray the circulated anolyte component on the vapor decomposition introduced into the separator tank to thereby quench and cool them to condense more anolyte.

Additionally or alternatively, a stream of cold inert gas may be injected into the separator tank and mixed with the vapor decomposition introduced thereinto. In a similar fashion, the cooled inert gas injected into the separator tank separates an anolyte component from the vapors which is removed from the separator tank through the fluid outlet. A gaseous mixture including a remainder of the vapor decomposition and inert gas is removed from the separator tank through the vapor outlet to the condenser, wherein the catholyte component is cooled, condensed and streamed to the catholyte vessel. The catholyte vessel may include a gas outlet used for removing the inert gas therefrom and recycle it back for use in the cold inert gas stream injected inside the separator tank.

Optionally, or additionally, the separator tank may include a heat exchanger coil through which cold fluid (e.g., water) may flow. The heat exchanger coil is configured to extract heat from the vapor decomposition introduced into the separator tank, to quench it and separate therefrom an anolyte component in a liquefied state.

The present disclosure also provides a method of converting thermal energy into electrochemical energy. The method comprises receiving a stream of catholyte composition in a fluid phase (e.g., from an electrochemical cell, after or during a discharge cycle thereof), heating the received catholyte composition to a predetermined temperature being a decomposition temperature of the catholyte composition, thereby producing a gaseous mixture comprising vaporized anolyte and catholyte components, cooling the gas mixture to separate an anolyte component from the vapors. In some embodiments the anolyte component is to be transferred for use in an anodic half-cell of an energy storage device and the remainder of the decomposed catholyte is to be transferred for use in a cathodic half-cell of the electrochemical cell. The method may comprise condensing a catholyte component from a remainder of the vapors mixture, and the catholyte component is to be transferred for use in the cathodic half-cell of the energy storage device.

The heating of the catholyte composition may be carried out using solar energy heat sources, or any other suitable heat source capable for heating the catholyte composition to its decomposition temperature.

One aspect of the present invention relates to an energy conversion system comprising a heating apparatus configured and operable to heat a catholyte composition from an electrochemical cell to a decomposition temperature thereof thereby producing a decomposed catholyte, and a separator configured and operable to receive said decomposed catholyte and separate anolyte component therefrom, thereby enabling use of the anolyte component and a remainder of the decomposed catholyte in anodic and cathodic half-cells of an electrochemical energy storage device. The system may comprise the electrochemical energy storage device, which may comprise a Na—S battery, being connected to the separator.

Optionally, the heating apparatus comprises a solar energy concentrator utilizing concentrated solar energy as a heat source for heating the catholyte composition in a solar reactor. To this end, in some embodiments the heating apparatus may comprise a solar reactor. For example and without being limiting, the solar reactor may be fabricated at least in part from at least one of graphite and ceramic, or a combination thereof.

In some embodiments the separator comprises a separator tank configured to separate the anolyte component and transfer it to the anodic half-cell, and a condenser configured to receive the remainder of the decomposed catholyte, separate catholyte component therefrom, and transfer the catholyte component to the cathodic half-cell. The separator tank may include an inlet configured to receive a cold fluid stream and inject it into the separator tank to facilitate separation of the anolyte component. For example and without being limiting, the cooled fluid stream may comprise at least one of cooled anolyte component and cold inert gas. Alternatively, or additionally, the separator tank may include a heat exchanger coil configured and operable for passage of a cold fluid therethrough to facilitate separation of the anolyte component.

In some embodiments the system includes a heat rejection device (e.g., heat exchanger) connected to the separator and configured to cool the separated anolyte component received from the separator tank. For example and without being limiting, the heat rejection device may be configured and operable to cool the separated anolyte component to a working temperature of the electrochemical energy storage device.

An anolyte vessel may be used in some embodiments to receive the separated anolyte component from the separator and transfer it to the anodic half-cell. A circulating line may be used to connect between the separator tank and the anolyte vessel for streaming portions of the cooled anolyte from the anolyte vessel to the inlet of the separator tank.

In some embodiments a catholyte vessel connected to the condenser of the separator is used to receive the separated catholyte component from the separator and transfer it to the cathodic half-cell. A gas recycle line connected to the catholyte vessel may be used for removing portions of the inert gas received in the catholyte vessel with the remainder of the decomposed catholyte for use in the cold fluid stream and inject it into the separator tank.

Another aspect of the present invention relates to a method of converting thermal energy into electrochemical energy, the method comprising receiving a catholyte composition in a fluid phase from an electrochemical cell, the catholyte composition comprising anolyte and catholyte components, heating (e.g., using solar energy) the catholyte composition to a decomposition temperature thereof, thereby producing a decomposed catholyte mixture, separating the anolyte component from the decomposed catholyte, transferring the anolyte component in a liquid state to an electrochemical cell for use in an anodic half-cell thereof, and transferring a remainder of the decomposed catholyte to the electrochemical cell for use in a cathodic half-cell thereof.

The method may include in some embodiments separating (condensing) a catholyte component from the remainder of the decomposed catholyte mixture to thereby obtain a separated catholyte component to be transferred for use in the cathodic half-cell.

In some possible embodiments separating of the anolyte component includes spraying over the decomposed catholyte mixture a cold fluid (i.e., mixing the decomposed catholyte mixture with the cold fluid) comprising at least one of a cold inert gas and cooled anolyte component. For example and without being limiting, the separating of the anolyte component may comprise circulating a portion of the separated anolyte component to spray a cold fluid stream thereof over the decomposed catholyte mixture. Alternatively, or additionally, separating of the anolyte component may comprise providing a heat exchanger, and streaming through the heat exchanger a cold fluid to thereby cool the decomposed catholyte.

Optionally, before transferring the anolyte component to the anodic half-cell, the anolyte component is cooled to a working temperature of the electrochemical cell, thereby producing a cooled anolyte component. In some possible embodiments spraying of the cold fluid comprises receiving portion of the cooled anolyte component and spraying the same over the decomposed catholyte.

Optionally, before transferring the catholyte component to the cathodic half-cell, the catholyte component is cooled to a working temperature of the electrochemical cell.

### BRIEF DESCRIPTION OF THE DRAWINGS

In order to understand the invention and to see how it may be carried out in practice, embodiments will now be described, by way of non-limiting example only, with reference to the accompanying drawings, in which like reference numerals are used to indicate corresponding parts, and in which:

FIG. 1 schematically illustrates a charge/discharge process in conventional Na—S battery cells;

FIG. 2 is a sectional view of a possible Na—S cell according to some possible embodiments;

FIGS. 3A and 3B show sodium polysulfide decomposition states and discharge state plots of Na—S battery cells, wherein FIG. 3A shows transits in the Na₂Sₓ and Sulfur concentrations relative to temperature changes, and FIG. 3B shows the changes in the electrical voltage of the Na—S battery cell relative to the changes in the sodium polysulfide decomposition;

FIGS. 4A and 4B are thermodynamic plots of Na₂Sₓ and Sulfur equilibrium compositions at 1 and 0.001 bar, respectively;

FIG. 5 is a plot of pressure influence on the extent of sodium polysulfide decomposition reaction at 1500° C.;

FIG. 6 schematically illustrates electrochemical storage of thermal energy in a battery according to some possible embodiments;

FIGS. 7A to 7C schematically illustrate various separation techniques of the present application for separating anolyte and catholyte components from vapor decomposition, wherein FIG. 7A demonstrates a technique wherein a cooled liquefied anolyte component is sprayed in a separator tank to extract more anolyte components from the vapors, FIG. 7B demonstrates a technique wherein cold inert gas is injected into the separator tank to quench the hot vapors and condense the anolyte components, and FIG. 7C demonstrates a technique utilizing heat exchanger coil to quench the hot vapors and extract the anolyte components; and

FIG. 8 is a flowchart illustrating a recharge process of an electrochemical cell according to some possible embodiments.

It is noted that the embodiments exemplified in the figures are not intended to be in scale and are in diagram form to facilitate ease of understanding and description.

### DETAILED DESCRIPTION OF EMBODIMENTS

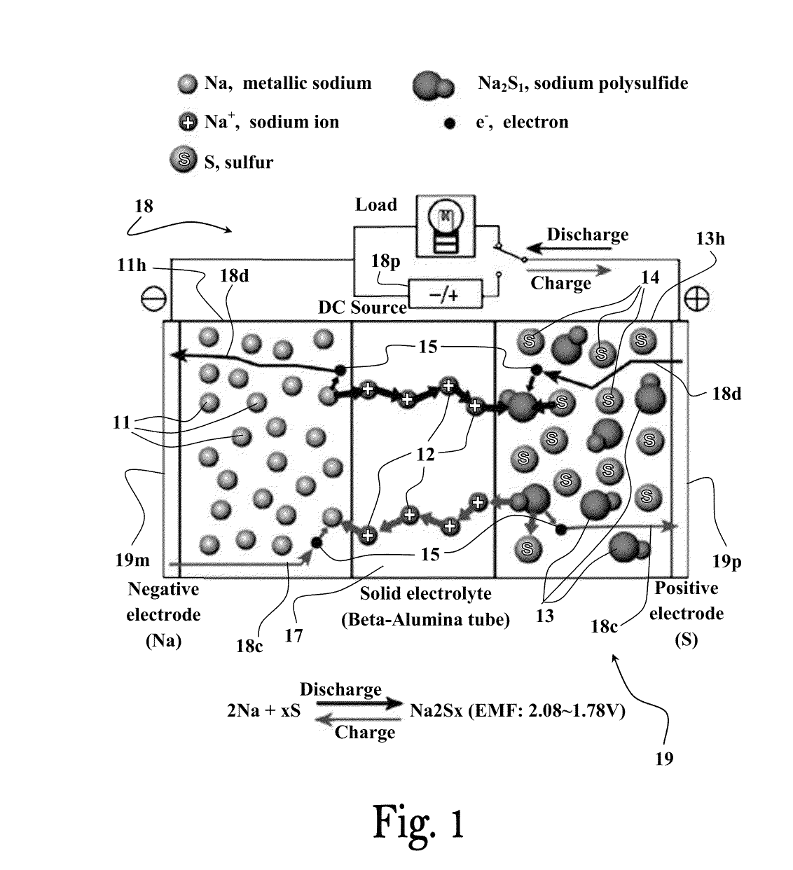

Recently there has been a growing interest in large-scale rechargeable batteries to enable substantial integration of renewable energy sources such as PV and wind into electrical grid systems. One such battery is known as a sodium-sulfur (Na—S) battery 19, which is based on Na⁺ conducting electrolyte membrane 17 (e.g., β-Al₂O₃ solid electrolyte—BASE) that separates between molten sodium anolyte 11 and a molten sulfur catholyte 14, as schematically illustrated in FIG. 1.

The operation of Na—S batteries is principally based on the discovery that a common ceramic refractory, sodium β-alumina (NaAl₁₁0₁₇), exhibits extremely high ionic conductivity for Na ions. At about 300° C., the ionic conductivity for NaAl₁₁0₁₇ approaches that of the aqueous electrolyte, H₂S0₄, suggesting the possibility of using NaAl₁₁O₁₇ as a solid electrolyte in a high temperature electrochemical cell. Na—S battery technology has been commercialized in Japan since 2002, where it is largely used in utility based load-leveling or peak-shaving applications. Na—S battery technology has been demonstrated at over 190 sites in Japan. More than 270 MW of stored energy suitable for 6 hours of daily peak shaving have been installed. The largest Na—S installation is a 34-MW power, 245-MWh energy storage unit alongside a 51 MW wind farm stabilizing the grid in Northern Japan. The demand for Na—S batteries as an effective means of stabilizing renewable energy output and providing ancillary services is expanding. U.S. utilities have deployed 9 MW for peak shaving, backup power, firming wind capacity, and other applications. Projections indicate that development of an additional 9 MW is in progress. Several projects are also under development in Europe and Japan (updated April 2010).

Possible Na—S battery implementations are described in U.S. Pat. Nos. 3,404,035 and 4,492,742. FIG. 1 demonstrates charge (designated by arrows 18c) and discharge cycles (designated by arrows 18d) of typical Na-S battery cell 19. In the discharge cycle, positive Na⁺ ions 12 pass from the anodic half-cell 11h through the electrolyte 17, and electrons 15 flow through the external electrical circuit 18 electrically connected to the battery terminals (19p and 19m). These types of cells are typically capable of producing an electrical voltage of about 2 volts. The battery process illustrated in FIG. 1 is reversible, and in the conventional charging cycle the sodium polysulfide molecules 13 are decomposed and caused to release the Na⁺ ions 12 back through the electrolyte 17 to recombine as elemental sodium 11 by connecting electrical power source 18p to the battery terminals 19p and 19m.

The half-cell and overall-cell reactions can be expressed as follows:

Anode: 2Na⇄2Na⁺+2e⁻ (1)

Cathode: xS+2Na⁺+2e⁻⇄Na₂Sₓ (2)

Overall cell reaction: xS+2Na⇄Na₂Sₓ (x=3, 4 or 5) (3)

The open circuit voltage of the cell 19 at 350° C. is typically about 2.075 V. The sodium-sulfur battery cell 19 usually works at temperatures ranging between 300 and 350° C., at which the sodium (Na) 11, sulfur (S) 14 and the reaction product (Na₂Sₓ) 13 of sodium polysulfide occur in the liquid state of these materials.

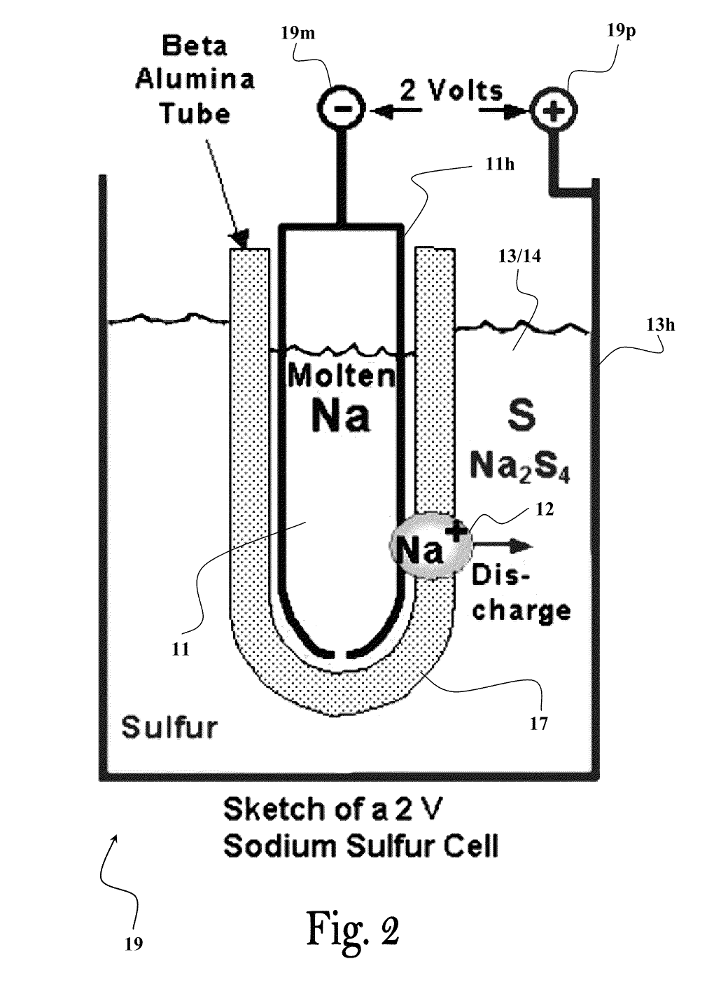

A sectional view of the Na—S battery cell 19 is schematically illustrated in FIG. 2, wherein the anodic half-cell 11h defined by a vessel made from the solid electrolyte 17 (e.g., Beta-Alumina tube) is immersed in the composition of the cathodic half-cell 13h.

Na—S batteries (19) exhibit high power, energy density, temperature stability, are relatively inexpensive and are considered to be safe. The specific energy density of these batteries is typically about 760 W-h/kg at 350° C., nearly three times the energy density of a lead-acid battery. These batteries also have high efficiency, of about 89-92% in total for charge/discharge cycle. In the embodiments disclosed herein only the discharge half cycle is done electrochemically through the battery membrane, and the recharge cycle is done externally by the thermal decomposition (i.e., the Na ions pass through the membrane only once during the discharge cycle (e.g., demonstrated by arrowed lines 18c in FIG. 1), whereas in the conventional electrical battery recharge they pass through the membrane also in the recharge cycles i.e., double pass, but in the opposite direction (e.g., arrowed lines 18d in FIG. 1), therefore the expected efficiency of the battery is greater than 90% half cell on the discharge part. Na—S batteries also have pulse power capabilities, over six times greater than their continuous discharge rating. These attributes enable the Na—S battery to be economically used in combined power quality and peak shaving applications.

Some properties of the Na₂Sₓ composition pertaining to the techniques of the present application will be now discussed herebelow.

The composition of the sodium polysulfide (Na₂ Sₓ) obtained at the cathodic half-cell 13h changes with the state-of-discharge of the battery 19. The changes in the sodium polysulfide composition are indicated by the number of Sulfur (S) atoms, i.e., designated by the value of x in the expression Na₂Sₓ.

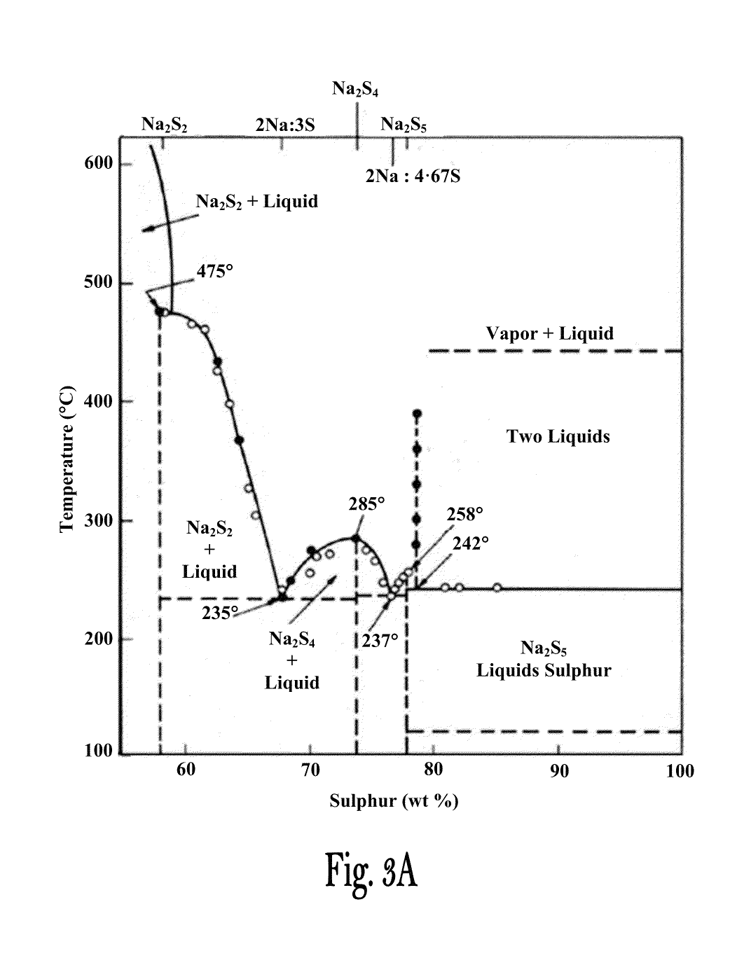

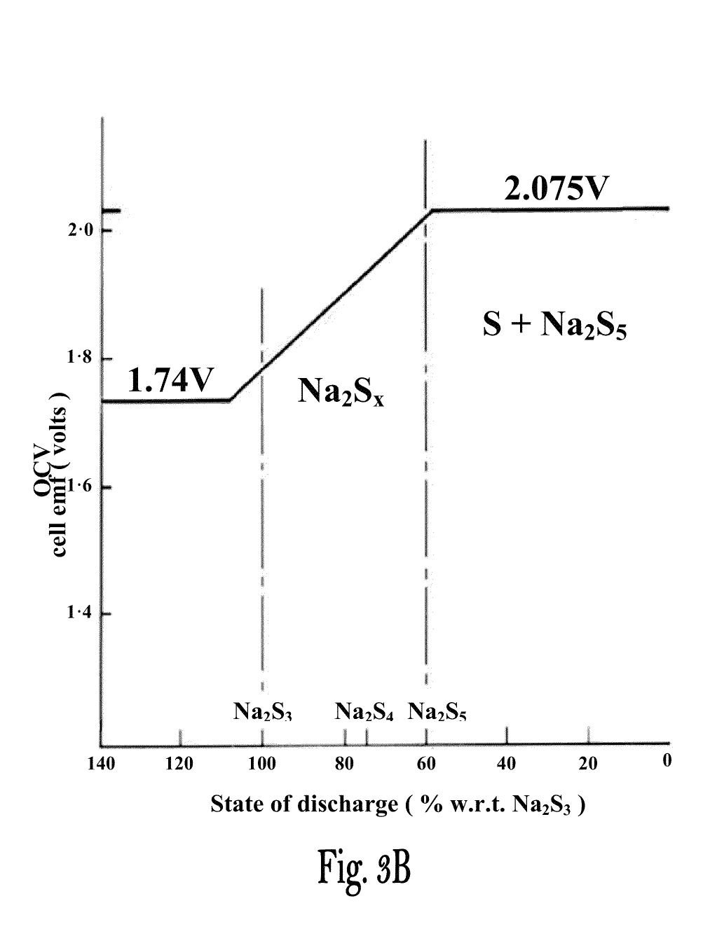

When in a high state-of-discharge, in which the electromotive force (i.e., cell EMF/voltage) is essentially constant (2.075 V), and at 300° C., the cathodic half-cell 13h consists of co-existing phases of both Sulfur and Na₂S₅ (up to 60% state-of-discharge). As the cell is further discharged the Sulfur atoms combine with the Na atoms to form single phase region with x<5. The electromotive force essentially linearly decreases as “x” decreases. At ˜80% state-of-discharge x=4 and at full discharge x=3 (and the cell voltage is reduced to 1.74 V). The dependency of the Na—S cell EMF on the state of the sodium polysulfide composition state, and the dependency of the sodium polysulfide composition state on the cell temperature is illustrated in FIGS. 3A and 3B.

The Na₂Sₓ composition properties discussed above are harnessed in various thermo-chemical charging techniques of the present application. Possible embodiments for thermo-chemical charging of Na—S cells utilizing concentrated solar energy as a heat source are explained below.

Instead of charging the Na—S battery with external source of electricity (18p in FIG. 1), as typically done today to decompose the Na₂Sₓ (13) compound back to its Na (11) and Sulfur (14) ingredients, the decomposition process according to some embodiments of the present invention is carried out thermally employing a suitable heat source, such as concentrated solar energy, for example. It is noted that a combined charging of the battery by electricity from a renewable resource like wind or PV and thermal may be carried out in some possible embodiments i.e., the recharging cycle includes both thermal recharging and the conventional electrical recharging.

The typical reaction in such process is as follows:

Na₂S₄→2Na+4S ΔH_{25C}=411.4 kJ/mol; ΔH_{1900C}=428.5 kJ/mol

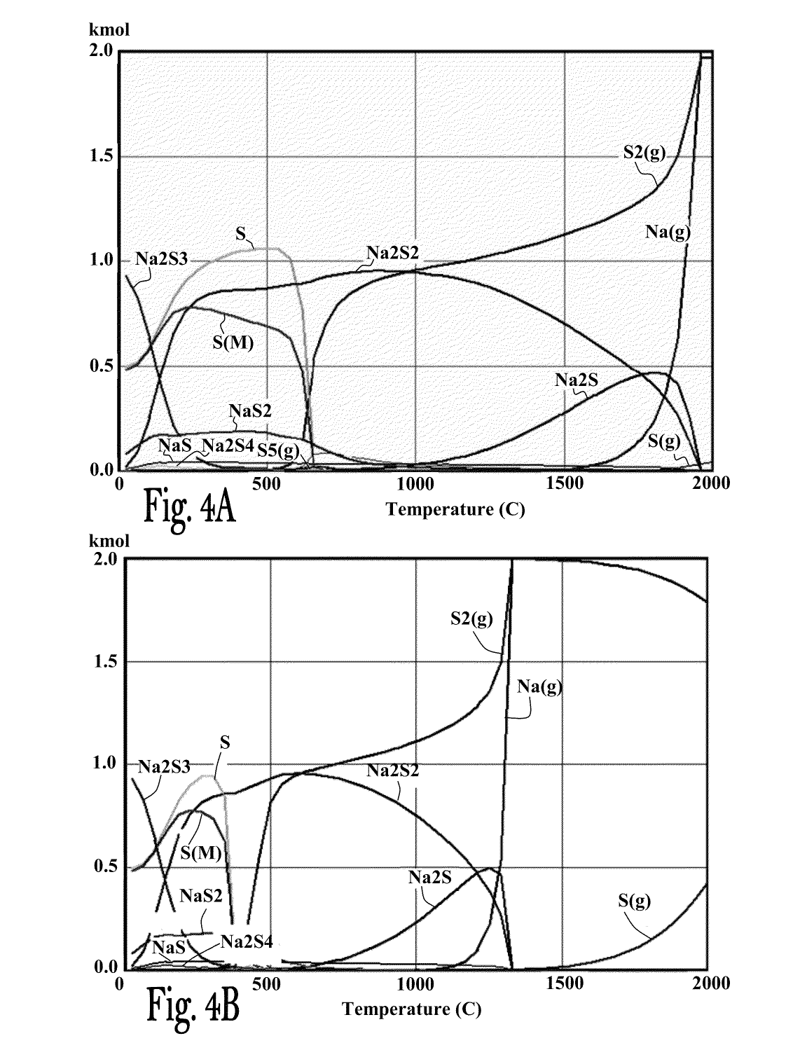

Thermodynamics show that the compounds Na₂S₄ or Na₂S₃, are similarly fully decomposed at about 1900° C. and 1 bar pressure, as seen in FIG. 4A, and at about 1400° C. and 0.001 bar absolute pressure, as seen in FIG. 4B. The decomposed products are gaseous mixtures of Sulfur and Sodium vapors that need to be quenched to below the boiling point of Na (e.g., 883° C. at atmospheric pressure) where the Na atoms can be separated in a liquid state, while the Sulfur atoms remains in their gaseous phase until cooled to about 444.6° C.

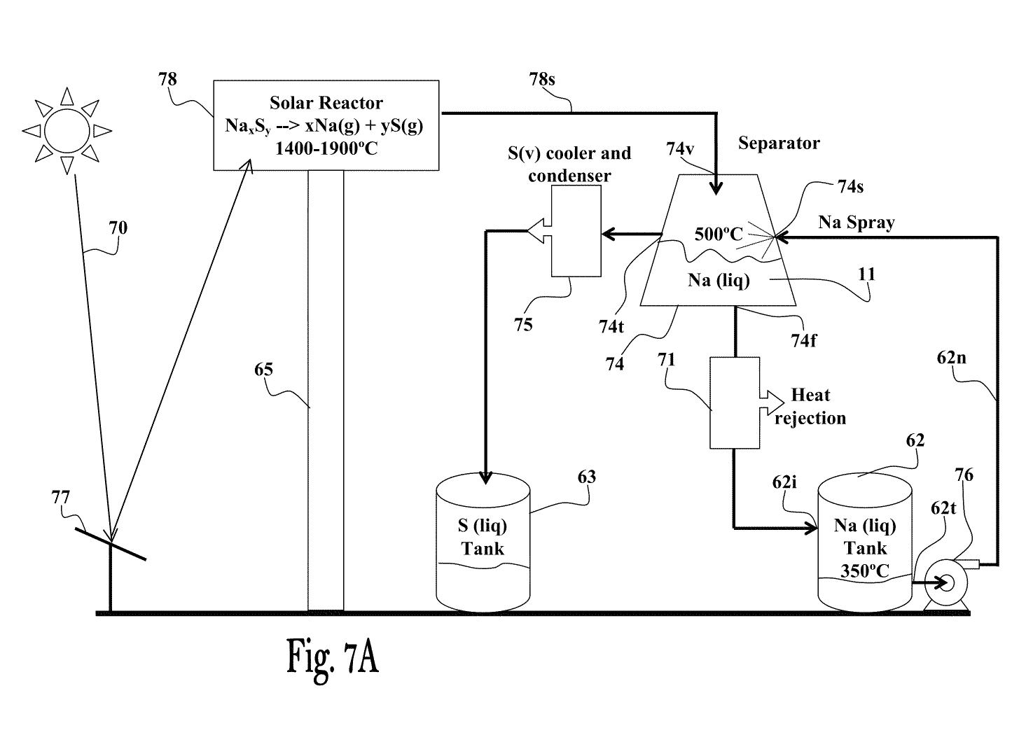

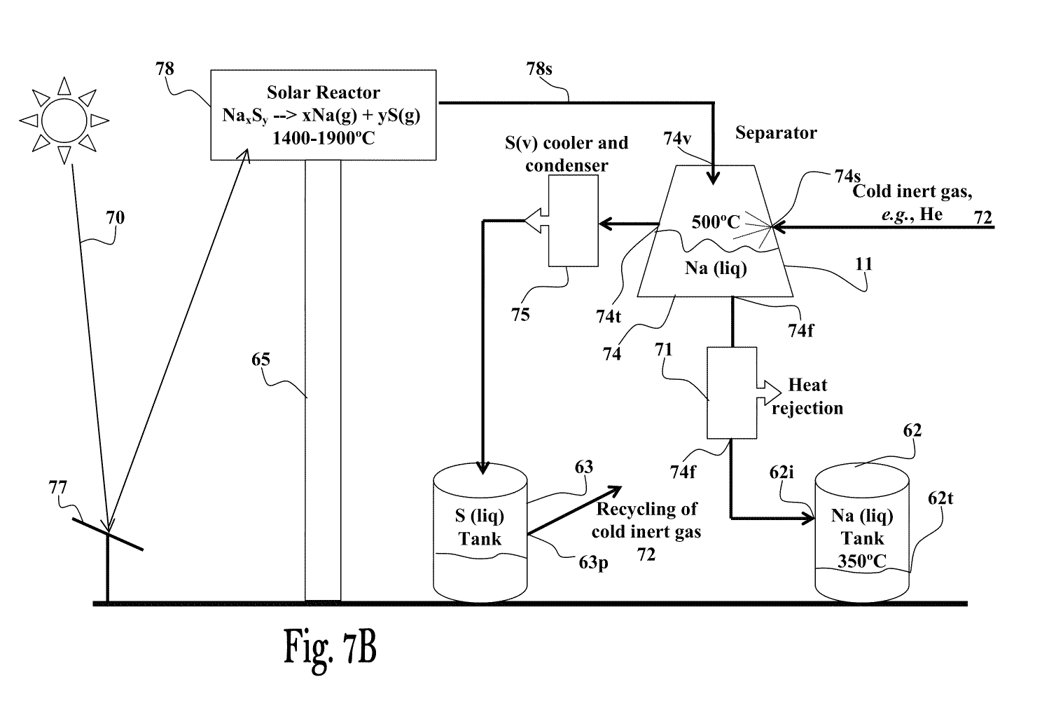

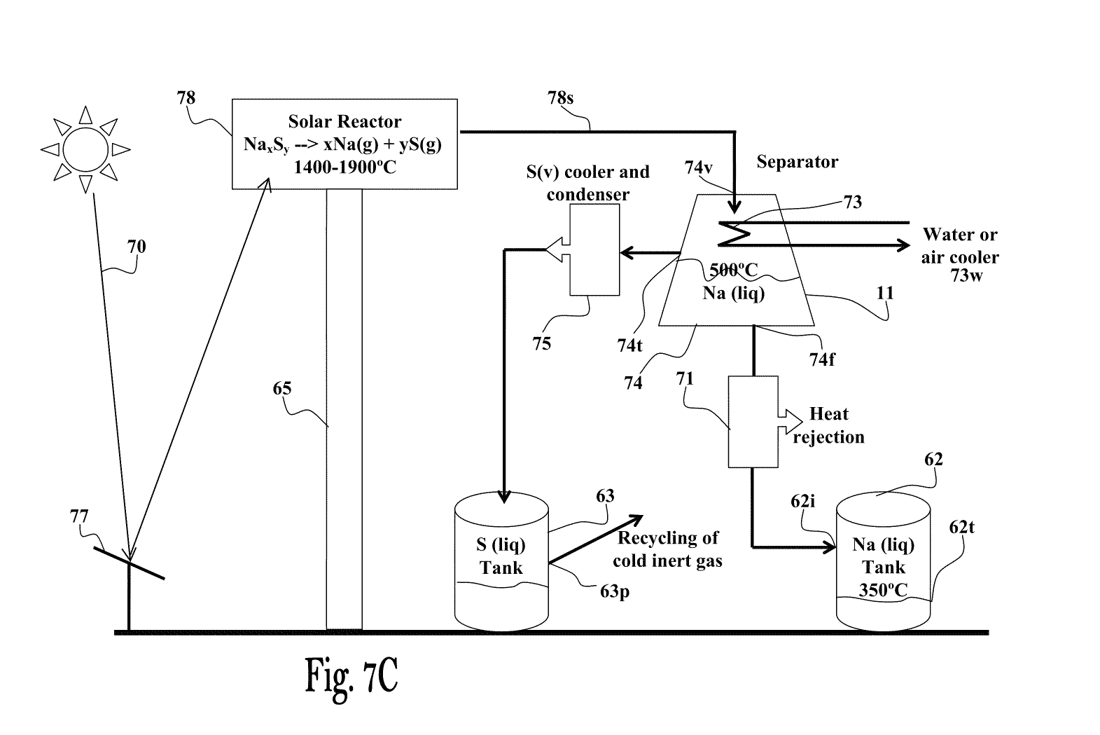

Accordingly, in possible embodiments of the present disclosure, the charging cycle of the Na—S battery 19 comprises heating at least a portion of the composition from the cathodic half-cell 13h to decompose the sodium polysulfide products (13) into its Na (11) and S (14) compounds. Separation of the decomposed products, according some embodiments, may be based on the fact that, while the decomposition vapors are being cooled, before condensation of the Sulfur atoms (14) is commenced, most of the Sodium atoms (11) become liquefied and separated (vapor pressure of Sodium at the 445° C. is about 1 mbar abs). The separated sodium (11) and sulfur (14) species may be further cooled to a temperature of about 350° C. in an external heat exchanger (e.g., using the condenser 75 and heat exchanger 71 shown in FIGS. 7A to 7C), at which stage they are respectively returned in liquid state to the anodic half-cell (11h) and cathodic half-cell (13h) of the Na—S battery 19 at its working temperature i.e., 350° C.

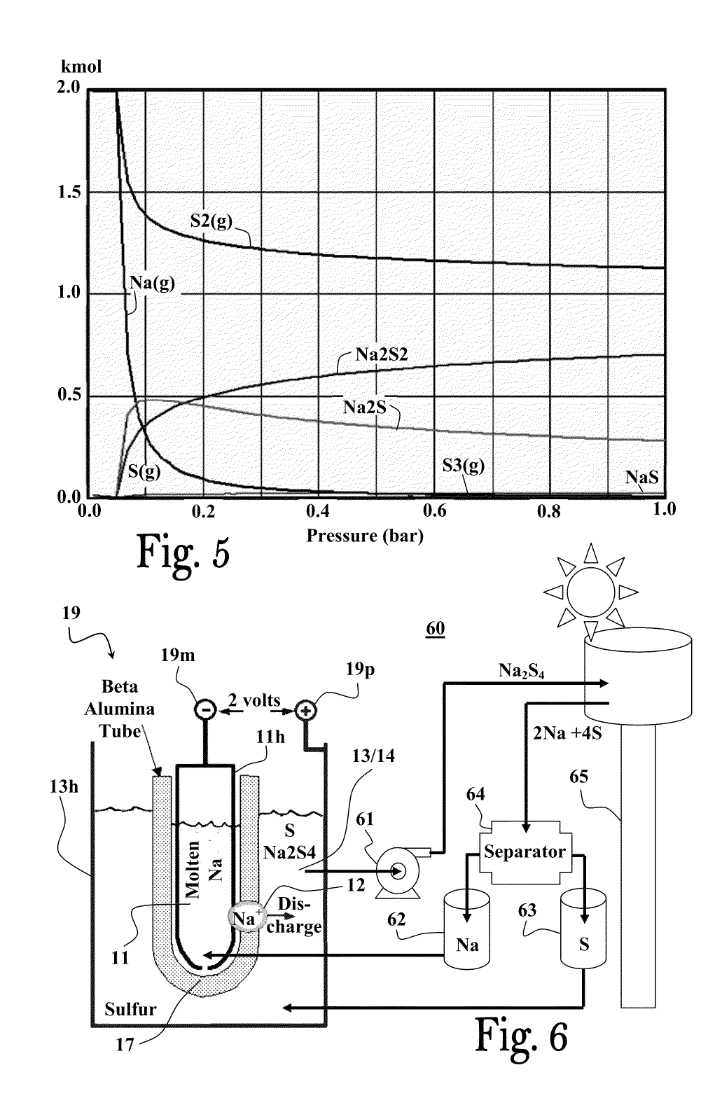

The influence of the pressure on the decomposition reaction of the sodium polysulfide (13) at 1500° C. is illustrated in FIG. 5. As seen in FIG. 5 at 1500° C. and about 50 millibar absolute pressure the Sodium polysulfide (13) is fully decomposed, compared to about 1900° C. required at a pressure of 1 bar (see, FIG. 4A).

A system 60 for thermo-electrochemical storage of solar energy according to some possible embodiments of the present invention is schematically illustrated in FIG. 6. In this example, in the charging cycle of the battery 19, portions of the sodium polysulfide composition 13 are pumped from the cathodic half-cell 13h of the battery 19 and heated in the heating apparatus 65 to decompose the pumped catholyte composition into its Na (11) and S (14) components e.g., 2Na+4S. Thereafter, the decomposed components are directed to the separator 64 wherein the decomposed vapor mixture is separated into its Na and S components, which are then respectively directed to Sodium vessel 62 and Sulfur vessel 63 for cooling them to the working temperature of the battery 19, before they may flow to their respective half-cells.

More particularly, pump 61 may direct a stream comprising sodium polysulfide composition (the catholyte composition after the discharge cycle) from the cathodic half-cell 13h to the heating apparatus 65. The sodium polysulfide composition is heated in the solar reactor of the heating apparatus 65 to its decomposition temperature and discharged therefrom in a form of Na and S decomposed vapors into the separator 64.

The separator is configured to quench and extract the Na and S components from the vapors, for example, in a first stage, by cooling the vapors to a temperature of about 460-500° C., in the case of atmospheric pressure, to liquefy the Na component and reduce substantially its vapor pressure (e.g., to about 2-8 mbar), and in a further stage, by extracting the S component by condensing the vapors remained after the cooling in the first stage.

The extracted Na and S components may be transferred to respective Sodium and Sulfur vessels, 62 and 63, for energy storage. The Na vessel 62 and the S vessel 63 may be configured to cool (e.g., using a cooling jacket or by circulating through cooling heat exchanger) the separated Na and S components to a working temperature of the battery 19 (e.g., about 350° C.), and thereafter permit passage of the cooled Na and S components to the anodic half-cell 11h and the cathodic half-cell 13h, respectively. The volumes of the anolyte and catholyte vessels, 62 and 63, may be set to determine the size of the energy storage (19) and the amount of energy stored in the system 60. The battery 19 has a limited storage volume and it is mainly used as an electrochemical converter during the discharge cycles commenced after each refill of its anodic and cathodic half-cells, 11h and 13h, from the anolyte and catholyte vessels, 62 and 63 respectively.

The heating apparatus 65 may be implemented in various ways employing any suitable heating technique. For example, in some possible embodiments of the present application the heating performed in the heating apparatus 65 utilizes renewable energy resources, such as, but not limited to, concentrated solar energy (e.g., employing a solar tower and/or dish).

In some possible embodiments of the present invention the heating apparatus 65 is configured to heat the sodium polysulfide composition 13 by solar energy. For example and without being limiting, the heating apparatus 65 may be a solar reactor (78 shown in FIGS. 7A-C) designed for decomposing Na₂Sₓ (x=3, 4) at temperatures of about 1500-1700° C. and pressures of about 0.01-1 bar absolute. Such possible solar reactor designs are described and illustrated in:

U.S. Pat. No. 5,947,114 (Kribus A., Karni J. and Doron P. “Central solar receiver with a multi component working medium”).

Karni et al., “The DIAPR: A high-pressure, high-temperature solar receiver”, J. Solar Energy Engineering 119, 74-78, 1997.

Kribus et al., “Performance of the Directly-Irradiated Annular Pressurized Receiver (DIAPR) operating at 20 bar and 1,200° C”, J. Solar Energy Engineering 123, 10-17, 2001.

At least some elements of the solar reactor may comprise, or be fabricated from, graphite. For example and without being limiting, such a solar reactor may comprise internal elements made from, or comprising graphite (e.g., graphite foam) configured to replace the ceramic configuration used in the above-referenced examples. Graphite may be preferable in some embodiments as it is a good light absorber, heat conductor and is chemically resistant to the Na₂Sₓ, Na and S substances involved in the decomposition process. However, other materials may be used together with, or instead of, graphite.

As discussed hereinabove, fast quenching (cooling) and separation of the sodium and sulfur vapor products received from solar tower are required in order to prevent recombination. Various vapor component separation techniques applicable in the thermo-electrochemical solar energy storage technique of the present application are illustrated in FIGS. 7A-C.

In some possible embodiments, the mixture of sulfur and sodium vapors are quenched by spraying cooled liquefied Sodium into the received vapors, as exemplified in FIG. 7A. More particularly, in this example a concentrator 77 (e.g., solar heliostat, dish, mirror array, or suchlike) is used to concentrate sun rays 70 onto the solar reactor 78 of the heating apparatus 65. The solar reactor 78 heats the sodium polysulfide composition from the cathodic half cell (13h) to about 1400-1900° C. under pressure conditions of about 0.01-1 bar, to thereby cause decomposition thereof into vaporized Sulfur and Sodium components. Vacuum pressure conditions of up to one bar absolute, corresponding to the temperatures range of 1400-1900° C. respectively, may be maintained by controllably maintaining the temperature in the separator 74 at about 500° C. and the temperature in the condenser 75 (on the remainder of the vapors) at about 350° C. At these temperatures the condensed phases have low vapor pressure and thus cause vacuum pumping effect over the solar reactor 78. The vapor decomposition is streamed into the separator tank 74 in which it is cooled (e.g., to about 460 to 480° C.) by recycled cooled (e.g., to about 350° C.) liquefied Sodium that is sprayed into the vapors.

Separator tank 74 may be implemented by a vessel made of stainless steel for example, having a vapor inlet 74v for receiving the hot vapors 78s streamed from the solar reactor and a spraying inlet for 74s (e.g., using a spraying manifold and/or nozzles/sprinkles) for spraying the cooled liquefied Sodium from the anolyte vessel 62 into the separator tank 74. The separator tank 74 further includes a top vapor outlet 74t for removing a remainder of the vapors, including the sulfur vapors, from the separator tank 74, and a fluid outlet 74f for removing liquefied Sodium from the separator tank 74.

As explained in detail below, in some embodiments the condensate liquid Sodium collected at the bottom of separator tank 74, and removed therefrom via the fluid outlet 74f to the sodium storage vessel 62, is passed through a heat exchanger 71 to further cool the extracted anolyte component to a temperature of about 350° C.

In this example the sprayed cooled/liquefied Sodium quenches the gas mixture 78s introduced into the separator tank 74 through the vapor inlet 74v to liquefy and separate the Sodium vapors from the vapor stream 78s, while the Sulfur component remains in gaseous phase. A remainder of the vapors, remaining after the quenching and the Sodium condensing, flows from the separator tank 74 via the vapor outlet 74t to a condenser 75 in which the Sulfur vapors are condensed by cooling them to about 360-380° C. The liquefied Sulfur is streamed from the condenser 75 into the Sulfur vessel 63 in which it may be stored at about 350° C., or close to the operating temperature of the battery, or it can be further cooled (e.g., using a cooling jacket) to about 150-180° C. for longer storage terms. The cooled liquefied Sulfur may be streamed from the Sulfur vessel 63 into the cathodic half-cell 13h of the battery 13, as illustrated in FIG. 6.

As demonstrated in FIG. 7A, the cooled liquefied Sodium 11 accumulating inside the separator tank 74 is streamed through the fluid outlet 74f into the Sodium vessel 62. The Sodium vessel 62 may be configured to cool/maintain (e.g., using external heat exchanger or a cooling jacket which extract and reject the heat absorbed by the sodium stream recycled through the separator 74) the liquefied Sodium 11 at a temperature of about 350° C., such that the cooled liquefied Sodium 11 may be streamed therefrom into the anodic half-cell 11h, as demonstrated in FIG. 6. The Sodium vessel 62 in this example is configured as both a storage and a circulating tank having a fluid inlet 62i through which the separated liquefied Sodium 11 is received thereinto, and a fluid outlet 62t through which a stream of cooled liquefied Sodium 11 is pumped by the pump 76 through a circulating line 62n to the spraying inlet 74s of the separator 74. Portions of the cooled Sodium 11 may be transferred to the anodic half-cell, simultaneously or intermittently, as may be needed.

Another possible vapor component separation technique is exemplified in FIG. 7B. The solar heating and decomposition elements shown in FIG. 7B are substantially similar, or identical, to those described hereinabove with reference to FIG. 7A. In this non-limiting example the streamed vapors 78s are cooled and separated in the separator 74 by injection of a cold inert gas 72 (e.g., Helium) into the separator 74 via the inlet 74s. The stream of cold inert gas 72 introduced into the separator 74 cools the vapor 78s and thereby liquefies Sodium vapors which accumulate inside separator 74 in a liquid form 11. The separated liquefied Sodium 11 is streamed via fluid outlet 74f into the Sodium vessel 62, and a remainder of the vapors (comprising Sulfur vapors and inert gas 72) flow via vapor outlet 74t through the condenser 75. Condensed liquefied Sulfur and inert gas 72 flows from the condenser 75 into the Sulfur vessel 63.

The separated components may be further cooled in their respective vessels 62 and 63 to the working temperature of the battery 19 and flow to their respective half-cells. For example, and without being limiting, in some embodiments the condensate liquid Sodium collected at the bottom of separator tank 74, and removed therefrom via the fluid outlet 74f to the sodium storage vessel 62, is passed through a heat exchanger 71 to further cool the extracted anolyte component to a temperature of about 350° C.

In this example the stream received from the condenser 75 comprises the condensed Sulfur and the inert gas 72. The condensed Sulfur accumulates at the bottom of the Sulfur vessel 63, and the inert gas 72 is removed via gas outlet 63p of the Sulfur vessel 63. The inert gas 72 removed via the gas outlet 63p may be then recycled and cooled for further use in separation of the vapors 78s in the separator 74.

FIG. 7C schematically illustrates yet another possible technique for vapor separation according to some embodiments of the present application. The solar heating and decomposition elements shown in FIG. 7C are substantially similar, or identical, to those described hereinabove with reference to FIGS. 7A and 7B. In this non-limiting example, the vapors 78s received in the separator 74 from the solar reactor 78 are cooled using a heat exchanger coil 73 inside the separator tank 74. A stream of cooling fluid 73w (e.g., air or water) is passed through the heat exchanger coil 73 to extract heat from the vapors 78s and liquefy and separate the Sodium component 11, which accumulates inside the separator 74 in liquid state.

In possible embodiments water is used as the cooled fluid 73w that passes through the heat exchanger coil 73. In such applications the heat absorbed via the heat exchanger coil 73 can raise steam which can be used to operate a regular turbine and generate electricity. In this way, efficiency of the entire system may be further increased.

In some embodiments the liquefied Sodium 11 which flows via the fluid outlet 74f is further cooled from about 500° C. to about 350° C. (or close to the operating temperature of the battery) by passing it through heat exchanger 71 and therefrom into the Sodium vessel 62, while the remaining vapors are removed from the separator tank 74 via the vapor outlet 74t to the condenser 75. The condensed Sulfur is streamed from the condenser 75 into the Sulfur vessel 63. The liquefied components may be further cooled in their respective vessels to the working temperatures of the battery 19 and streamed into their respective half-cells.

The condenser 75 in some embodiments is implemented as a conventional condenser which may be made, for example, from any suitable metallic material e.g., stainless steel.

The cooling and separating of the Na and S components from the vapor decomposition may be carried out using any one of the techniques of the present application described hereinbelow, or any combination of these techniques.

As exemplified above, the anolyte component extracted in the separator may be condensed and separated as liquid at a temperature of about 500° C., and then further cooled by a heat rejection device (e.g., heat exchanger 71) to a temperature of about 350° C. and stored in the anolyte vessel 62. The heat rejection device (71) removes out of the system the heat required to quench the vapors. The separator 74 operates at a temperature of about 500° C. and at more or less the same pressure as in the solar reactor 78, where the sodium polysulfide is decomposed, in order to maintain the sulfur in its gaseous phase.

The condensed anolyte (Na) may be further cooled e.g., to about 350° C. before it is recycled to the separator. The heat rejection may be carried out by external heat exchanger, wherein the extracted heat may be utilized to operate a steam turbine and thereby generate more electricity. Accordingly, solar heat absorbed in the solar reactor 78 is partly invested in chemical decomposition, while a large portion thereof is absorbed as sensible heat in the system components. The heat absorbed in the system should be rejected, and therefore in some embodiments, some heat is removed by first quenching the gaseous mixture 78s in the separator 74 to minimize the back reaction, and thereafter further heat is removed by both condensing the Sulfur in condenser 75 and cooling the anolyte (Na) by external heat exchanger 71 to the battery operating temperature.

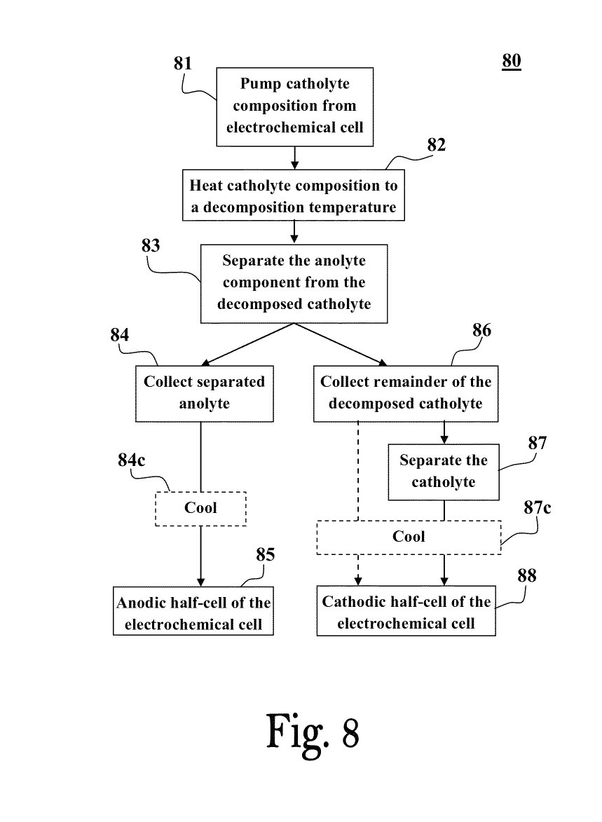

FIG. 8 is a flowchart illustrating a process 80 for recharging an electrochemical cell according to some possible embodiments. The process starts in step 81 by pumping a catholyte composition from an electrochemical cell (19). In step 82 the pumped catholyte composition is heated to a decomposition temperature, and in step 83 an anolyte component is decomposed from the decomposition. Next, in step 84 the separated anolyte is collected, and optionally cooled (e.g., to a working temperature of the electrochemical cell, designated by dashed box 84c), and in step 85 transferred to an anodic half-cell of the electrochemical cell.

A remainder of the decomposition is collected in step 86 and processed in steps 86-88 as follows; in step 87 the remainder of the decomposition undergoes catholyte separation in which a catholyte component is separated and in step 88 transferred to a cathodic half-cell of the electrochemical cell. Alternatively, the remainder of the decomposition obtained in step 86 may be transferred directly to the cathodic half-cell of the electrochemical cell (indicated by dashed arrowed line) without carrying out the separation step 87. An optional cooling step (designated by dashed box 87c) may be included to cool (e.g., to a working temperature of the electrochemical cell) the separated catholyte (or the remainder of the decomposed catholyte) before transferring it to the catholyte half-cell.

Some of the economical benefits associated with electrochemical storage of thermal energy in Na-S battery cells according to embodiments of the present application are discussed below.

The embodiments disclosed herein provide innovative and unique energy storage techniques which may be used for storage of reusable, recyclable or renewable thermal energy (e.g., solar energy) with built-in conversion efficiency of at least 90%, from storage to electricity. An implementation of the storage system using solar energy sources may provide solar to electricity (DC) conversion efficiencies of about 50%, assuming about 60% efficiency of the solar process (optical and thermal losses). This is more than twice the current commercial conversion peak efficiency from solar to electricity. From an economical point of view, investment in the power block in a regular solar power plant is avoided (estimated as 20-25% of the total cost of the plant). Production of steam or operation of any turbine is avoided in this new concept. The avoidance of the regular steam turbine preclude the need for water cooling, in desert areas where solar plants are typically deployed, which overcomes a significant hurdle in the implementation of solar power technology.

In possible embodiments of the present application the DC current produced when discharging the battery can be converted to AC, or directly transmitted as high voltage DC over transmission lines. Additionally, the Na-S battery can be still shared, in parallel to the solar thermal plant, with other renewable energy resources such as PV and wind which may be connected to a joint smart grid.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. An energy conversion system, comprising:
a heating apparatus configured and operable to heat a catholyte composition to a decomposition temperature thereof thereby producing a decomposed catholyte; and
a separator configured and operable to receive said decomposed catholyte and separate anolyte component therefrom, thereby enabling use of the anolyte component and a remainder of the decomposed catholyte in anodic and cathodic half-cells of an electrochemical energy storage device.

2. The energy conversion system of claim 1, comprising the electrochemical energy storage device connected to said separator, the electrochemical energy storage device comprising a Na—S battery.

3. The system of claim 1, wherein the heating apparatus comprises a solar energy concentrator, thereby utilizing concentrated solar energy as a heat source for heating the catholyte composition.

4. The system of claim 1 wherein the heating apparatus comprises a solar reactor fabricated at least in part from at least one of graphite and ceramic, or a combination thereof.

5. The system of claim 1 wherein the heating apparatus is configured and operable to heat the catholyte composition to a temperature in the range of 1400 to 1900° C.

6. The system of claim 1 wherein the heating apparatus is configured and operable to heat the catholyte composition under application of vacuum conditions of about 0.01 to 1 bar to the catholyte composition.

7. The system of claim 1 wherein the separator is configured and operable to cool the decomposed catholyte to thereby cause said separation.

8. The system of claim 7, wherein the separator is configured and operable to cool the decomposed catholyte to a temperature of about 460-500° C.

9. The system of claim 1 wherein the separator is configured and operable to separate the anolyte component under application of vacuum conditions lower than the vacuum conditions in the heating apparatus.

10. The system of claim 1 wherein the separator comprises:
a separator tank configured to separate said decomposed catholyte to the anolyte component and the remainder of the decomposed catholyte, said separator tank being in a fluid connection with the anodic half-cell thereby transferring the anolyte component in a liquid phase to said anodic half-cell; and
a condenser configured to receive the remainder of the decomposed catholyte in a gas phase, and separate a catholyte component therefrom, the condenser being in a fluid connection with the cathodic half-cell to thereby transfer said separated catholyte component in a liquid phase to the cathodic half-cell.

11. The system of claim 10 wherein the condenser is configured and operable to cool the remainder of the decomposed catholyte to a working temperature of the electrochemical energy storage device.

12. The system of claim 10, comprising an anolyte vessel for receiving the separated anolyte component in the liquid phase, for transferring at least a portion thereof to the anodic half-cell.

13. The system of claim 10, wherein the separator tank includes an inlet configured to receive a cold fluid stream and inject it into said separator tank to facilitate separation of the anolyte component.

14. The system of claim 13, comprising a circulating line connecting between inlet of the separator tank and the anolyte vessel for streaming a portion of the cooled anolyte therefrom to said inlet.

15. The system of claim 13, wherein said cooled fluid steam comprises a cold inert gas.

16. The system of claim 10 wherein the separator tank includes a heat exchanger configured and operable for passage of a cold fluid therethrough to facilitate separation of the anolyte component.

17. The system of claim 1, comprising a heat exchanger connected to the separator and configured to cool the separated anolyte component flowing out of the separator.

18. The system of claim 17 wherein said heat exchanger device is configured to cool the separated anolyte component to a working temperature of the electrochemical energy storage device.

19. The system of claim 10 comprising a catholyte vessel connected to the condenser of said separator to receive the separated catholyte component flowing from the condenser for transferring it to the cathodic half-cell.

20. The system of claim 19, comprising a gas recycle line connected to the catholyte vessel for removing portions of the inert gas from the remainder of the decomposed catholyte and injecting the inert gas back into the separator tank for use in a cold fluid stream facilitating the separation.

21. The system of claim 19, wherein the catholyte and anolyte vessels are configured and operable to cool and maintain the catholyte and anolyte components respectively in a working temperature of the electrochemical energy storage device.

22. A method of converting thermal energy into electrochemical energy, the method comprising:
receiving a catholyte composition in a fluid phase from an electrochemical cell after or during discharging of said cell,
heating said received catholyte composition to a predetermined temperature being a decomposition temperature of the catholyte composition, thereby producing a decomposed catholyte mixture in a gas phase;
separating an anolyte component in a liquid phase from the decomposed catholyte mixture, thereby enabling transferring said anolyte component to an electrochemical cell for use in an anodic half-cell thereof, and transferring the remainder of said decomposed catholyte for reuse in a cathodic half-cell thereof of an electrochemical cell.

23. The method of claim 22, comprising condensing the remainder of the decomposed catholyte mixture for separating a catholyte component from the mixture thereby obtaining a separated catholyte component to be transferred for use in the cathodic half-cell.

24. The method of claim 22, wherein the separating of the anolyte component comprises spraying over the decomposed catholyte mixture, a cold fluid stream.

25. The method of claim 24, wherein said cold fluid stream comprises at least a cold inert gas.

26. The method of claim 24, wherein the separating of the anolyte component comprises circulating a portion of the separated anolyte component to spray a cold fluid stream thereof over the decomposed catholyte mixture.

27. The method of claim 22, wherein the separating of the anolyte component comprises streaming a cold fluid through a heat exchanger thereby cooling the decomposed catholyte mixture.

28. The method of claim 22, comprising cooling the separated anolyte component to a working temperature of the electrochemical cell, thereby producing a cooled anolyte component to be transferred to the anodic half-cell.

29. The method of claim 23, wherein said condensing comprises cooling the remainder of catholyte mixture to a working temperature of the electrochemical cell.

30. The method of claim 22, wherein the heating of the catholyte composition comprises is carried out using concentrating solar energy to heat a solar reactor containing said catholyte composition.
